(19) United States
(12) Patent Application Publication
(10) Pub. No.: US 2013/0027205 A1
(43) Pub. Date: Jan. 31, 2013

(54) AUTOMATIC CONFIGURATION PROTOCOL FOR A PATIENT MONITORING NETWORK

(71) Applicant: Bryan Hansen, Mead, CO (US)

(72) Inventor: Bryan Hansen, Mead, CO (US)

(73) Assignee: Nellcor Puritan Bennett LLC, Boulder, CO (US)

(21) Appl. No.: 13/191,977

(22) Filed: Jul. 27, 2011

(51) Int. Cl. G08B 23/00

(52) U.S. Cl. 340/573.1

(57) ABSTRACT

A patient monitoring network may include patient monitoring units including patient monitors and monitoring stations. A patient monitor may be part of a patient monitoring system including devices for monitoring physiological activity of a patient and the patient monitor. A monitoring station may include a display and user interface to allow for monitoring of one or more patient monitors. The patient monitoring units may be connected to a network. A broadcast communication may be used by a patient monitoring unit to identify an address of other patient monitoring units. Patient monitoring units may then engage in addressed communications to allow for the display of information from one or more patient monitors at one or more monitoring stations.

The present disclosure relates to a patient monitoring network, and more particularly relates to an automatic configuration protocol for a patient monitoring network.

### SUMMARY

A patient monitoring network may include patient monitoring systems in communication with monitoring stations. A patient monitoring system may include a patient monitor and one or more sensors for monitoring physiological activity of a patient. The patient monitor may receive and process (e.g., by receiving, analyzing, displaying, and communicating) sensor data. A monitoring station may include a display and user interface to allow for monitoring of one or more patient monitors. One or more patient monitors and one or more monitoring stations may be connected to a network, e.g., using WiFi or a local area network connection. A broadcast (e.g., user datagram protocol) communication may be transmitted by a patient monitoring unit (e.g., a patient monitor or monitoring station) to request information from other patient monitoring units. The broadcast message may include, e.g., an internet protocol address of the transmitting unit. The receiving patient monitoring unit(s) may respond with identifying information such as an internet protocol address of the receiving unit(s). Patient monitoring units may then engage in addressed communications (e.g., using the transmission control protocol) to allow information from one or more patient monitors to be displayed at one or more monitoring stations.

### BRIEF DESCRIPTION OF THE FIGURES

The above and other features of the present disclosure, its nature and various advantages will be more apparent upon consideration of the following detailed description, taken in conjunction with the accompanying drawings in which:

FIG. 1 shows an illustrative patient monitoring system, in accordance with some embodiments of the present disclosure;

FIG. 2 shows a table of illustrative parameters for which an alarm may be activated, in accordance with some embodiments of the present disclosure;

FIG. 3 shows an illustrative display of a patient monitor, in accordance with some embodiments of the present disclosure;

FIG. 4 shows an illustrative patient monitoring network, in accordance with some embodiments of the present disclosure;

FIG. 5 is an illustrative monitoring station, in accordance with some embodiments of the present disclosure;

FIG. 6 is a flow diagram of illustrative steps for establishing communications in a patient monitoring network, in accordance with some embodiments of the present disclosure;

FIG. 7 is a flow diagram of illustrative steps for establishing communications in a patient monitoring network, in accordance with some embodiments of the present disclosure;

FIG. 8 shows an illustrative patient monitoring network, in accordance with some embodiments of the present disclosure; and

FIG. 9 shows an illustrative communication architecture for a patient monitoring network, in accordance with some embodiments of the present disclosure.

### DETAILED DESCRIPTION OF THE FIGURES

The present disclosure is directed towards methods and systems for configuring a patient monitoring network. In some embodiments, the patient monitoring network may include patient monitoring units. Patient monitoring units may include patient monitors for monitoring physiological activity of a patient and monitoring stations for remotely monitoring and displaying information from one or more patient monitors. Each patient monitor and each monitoring station may have a unique ID.

A patient monitor may be part of a patient monitoring system. An example of a patient monitoring system may be an oximeter, which is a medical device that may determine the oxygen saturation of the blood. One common type of oximeter is a pulse oximeter, which may indirectly measure the oxygen saturation of a patient's blood (as opposed to measuring oxygen saturation directly by analyzing a blood sample taken from the patient). Pulse oximeters may be included in patient monitoring systems that measure and display various blood flow characteristics including, but not limited to, the oxygen saturation of hemoglobin in arterial blood. Such patient monitoring systems may also measure and display additional physiological parameters, such as a patient's pulse rate and blood pressure.

An oximeter may include a light sensor that is placed at a site on a patient, typically a fingertip, toe, forehead or earlobe, or in the case of a neonate, across a foot. The oximeter may use a light source to pass light through blood perfused tissue and photoelectrically sense the absorption of the light in the tissue. In addition, locations which are not typically understood to be optimal for pulse oximetry serve as suitable sensor locations for the blood pressure monitoring processes described herein, including any location on the body that has a strong pulsatile arterial flow. A signal representing light intensity versus time or a mathematical manipulation of this signal (e.g., a scaled version thereof, a log taken thereof, a scaled version of a log taken thereof, etc.) may be referred to as the photoplethysmograph (PPG) signal. In addition, the term “PPG signal,” as used herein, may also refer to an absorption signal (i.e., representing the amount of light absorbed by the tissue) or any suitable mathematical manipulation thereof. The light intensity or the amount of light absorbed may then be used to calculate any of a number of physiological parameters, including an amount of a blood constituent (e.g., oxyhemoglobin) being measured as well as a pulse rate and when each individual pulse occurs.

In some applications, the light passed through the tissue is selected to be of one or more wavelengths that are absorbed by the blood in an amount representative of the amount of the blood constituent present in the blood. The amount of light passed through the tissue varies in accordance with the changing amount of blood constituent in the tissue and the related light absorption. Red and infrared (IR) wavelengths may be used because it has been observed that highly oxygenated blood will absorb relatively less Red light and more IR light than blood with a lower oxygen saturation. By comparing the intensities of two wavelengths at different points in the pulse cycle, it is possible to estimate the blood oxygen saturation of hemoglobin in arterial blood.

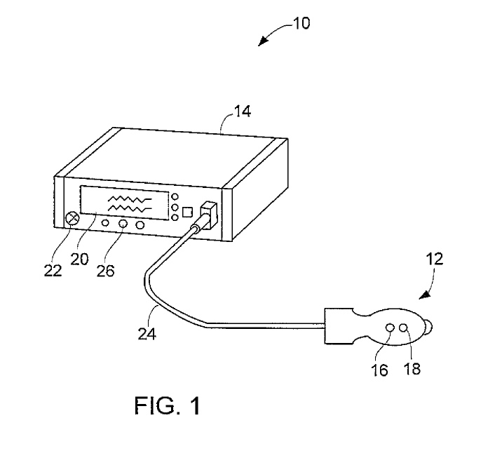

FIG. 1 is a perspective view of an embodiment of a patient monitoring system 10. Patient monitoring system 10 may include sensor unit 12 and patient monitor 14. In some embodiments, sensor unit 12 may be part of an oximeter. In such embodiments, sensor unit 12 may include an emitter 16 for emitting light at one or more wavelengths into a patient's tissue. A detector 18 may also be provided in sensor 12 for detecting the light originally from emitter 16 that emanates from the patient's tissue after passing through the tissue. Any suitable physical configuration of emitter 16 and detector 18 may be used. In an embodiment, sensor unit 12 may include multiple emitters and/or detectors, which may be spaced apart. System 10 may also include one or more additional sensor units (not shown) which may take the form of any of the embodiments described herein with reference to sensor unit 12. An additional sensor unit may be the same type of sensor unit as sensor unit 12, or a different sensor unit type than sensor unit 12. Multiple sensor units may be capable of being positioned at two different locations on a subject's body; for example, a first sensor unit may be positioned on a patient's forehead, while a second sensor unit may be positioned at a patient's fingertip.

Sensor units may each detect any signal that carries information about a patient's physiological state, such as an electrocardiograph signal, arterial line measurements, or the pulsatile force exerted on the walls of an artery using, for example, oscillometric methods with a piezoelectric transducer. It will be understood that any type of sensor, including any type of physiological sensor, may be used in one or more sensor units in accordance with the systems and techniques disclosed herein. It is understood that any number of sensors measuring any number of physiological signals may be used to determine physiological information in accordance with the techniques described herein.

In some embodiments, sensor unit 12 may be connected to and draw its power from patient monitor 14 as shown. In another embodiment, the sensor may be wirelessly connected to patient monitor 14 and include its own battery or similar power supply (not shown). Patient monitor 14 may be configured to calculate physiological parameters (e.g., pulse rate, blood pressure, and/or blood oxygen saturation) based at least in part on data received from one or more sensor units such as sensor unit 12. In an alternative embodiment, the calculations may be performed on the sensor units or an intermediate device and the result of the calculations may be passed to patient monitor 14. Further, patient monitor 14 may include a display 20 configured to display the physiological parameters or other information about the system. Patient monitor 14 may be configured to calculate physiological parameters to display on display 20. For example, patient monitor 14 may be configured to display an estimate of a patient's blood oxygen saturation generated (referred to as a “SpO₂” measurement), pulse rate information, blood pressure, and/or any other suitable physiological parameter on display 20. In the embodiment shown, patient monitor 14 may also include a speaker 22 to provide an audible sound that may be used for various purposes such as for example, sounding an audible alarm in the event that a patient's physiological parameters are not within a predefined normal range. In some embodiments, the patient monitor 14 includes a blood pressure monitor. In some embodiments, the system 10 includes a stand-alone blood pressure monitor in communication with the patient monitor 14 via a cable or a wireless network link.

Patient monitor 14 may include a processor such as a microprocessor that may determine the patient's physiological parameters, such as SpO₂, pulse rate, blood pressure, and/or any other suitable physiological parameters, using various algorithms and/or look-up tables based on the value of the received signals and/or data corresponding to the light received by detector 18. Physiological parameter signals corresponding to information about a patient including, for example, the intensity of light emanating from a patient's tissue over time, may be transmitted to enable the microprocessor to determine measurement and alarm thresholds based at least in part on algorithms or look-up tables stored in memory of patient monitor 14. Patient monitor 14 may also include memory for storing measured or calculated physiological parameters, patient information, information relating to sensor unit 12, and other data or information for the operation of patient monitoring system 10.

In some embodiments, user interface 26 may be provided to allow a user to select information, navigate menus and interact with display 20. User interface may include buttons, knobs, touchscreen, or any other interface that allows a user to interact with system 10. User interface 26 may be used enter information, select one or more options, provide a response, input settings, perform any other suitable inputting function, or any combination thereof. User interface 26 may be used to enter information about the patient, such as age, weight, height, diagnosis, medications, treatments, and so forth. In some embodiments, display 20 may exhibit a list of values which may generally apply to the patient, such as, for example, age ranges or medication families, which the user may select using user interface 26. In some embodiments, display 20 may exhibit one or more selectable options such as alarm settings, alarm sensitivity, or both which the user may select using user interface 26.

It will be understood that the present disclosure is not limited to any particular type of patient monitor. In accordance with the present disclosure, patient monitors may monitor any suitable biosignals including, for example, electrocardiograms, electroencephalograms, electrogastrograms, electromyograms, pulse rate signals, PPG signals, blood pressure signals, respiratory signals, pathological signals, ultrasound signals, any other suitable signals, or any combination thereof.

Patient monitor 14 may also include one or more mechanisms to facilitate communication with other devices in a network environment, such as one or more monitoring stations. For example, patient monitor 14 may include (internally or attached) transceivers such as a network port (such as an Ethernet port), a WiFi card, or any other device that allows signals to be exchanged between a patient monitor and other devices on a network, such as servers, routers, monitoring stations, workstations, and so forth. In some embodiments, such network functionality may be facilitated by the inclusion of a networking chipset within the patient monitor 14, by a processor of patient monitor 14, a module such as a network interface card, an external device that connects to a port of patient monitor 14, or combinations of the above.

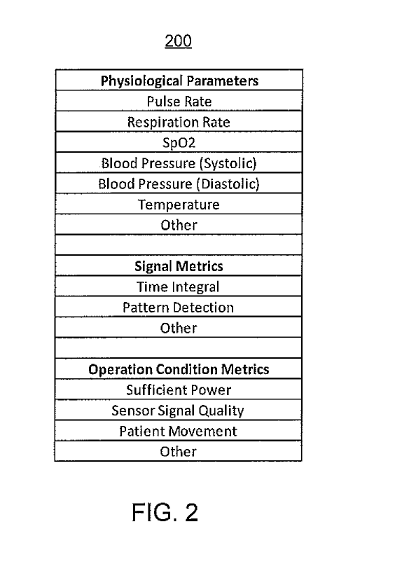

FIG. 2 shows a table 200 of illustrative physiological parameters, signal metrics, and operating condition metrics, in accordance with some embodiments of the present disclosure. A patient monitoring system (e.g., patient monitoring system 10 of FIG. 1) may be configured to provide alarms, warnings or other indicators based at least in part on one or more alarm settings. In some embodiments, a patient monitoring system (e.g., patient monitoring system 10 of FIG. 1) may be configured to provide alarms, warnings or other indicators based at least in part on the value of a signal (e.g., a voltage), a physiological parameter such as, for example, SpO₂, pulse rate, respiration rate, blood pressure, changes in any of the foregoing, computed quantities of any the foregoing, trends of the foregoing, any other suitable basis for providing an alarm, or any combination thereof. In some embodiments, a patient monitoring system may be configured to provide alarms, warnings or other indicators based at least in part on signal metrics such as, for example, plethysmograph waveform pattern, time integral of signal excursion outside of a limit, any other suitable signal metric for providing an alarm, or any combination thereof. In some embodiments, a patient monitoring system may be configured to provide alarms, warnings or other indicators based at least in part on operating condition metrics such as, for example, sufficient power (e.g., sensor power delivered), sensor signal quality (e.g., sensor signal strength, signal noise level), patient and/or sensor movement, any other suitable operating condition metric for providing an alarm, or any combination thereof.

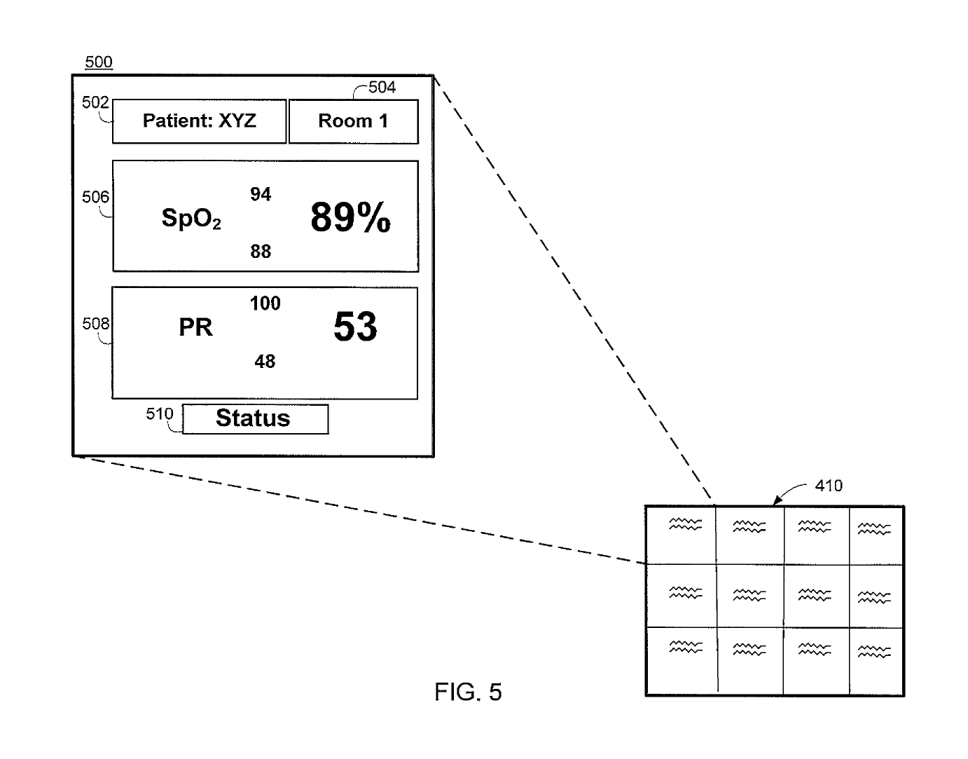

Alarms, warnings and other indicators may be based on a comparison of a suitable value with a limit threshold (e.g., a value less than a lower limit), comparison of a slope or change with a change threshold (e.g., a rate of change greater than a rate threshold), a trend (e.g., value increasing, first derivative decreasing), a duration that an alarm condition is achieved (e.g., a value greater than a high limit for a particular amount of time), an integral of a deviation of a time series with a suitable alarm limit (e.g., as shown in FIG. 5), a number of limit violations (e.g., over a time interval), any other suitable comparison or determination, or any combination thereof.

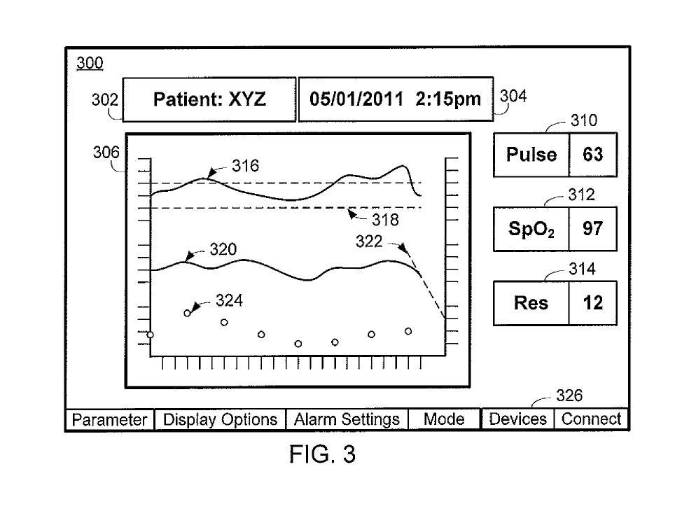

FIG. 3 shows an illustrative display 300 of a physiological monitoring system, in accordance with some embodiments of the present disclosure. Display 300 may include any suitable physiological information, identifying information, alarm information, any other suitable information, or any combination thereof. As illustratively shown in FIG. 3, display 300 for a patient monitor 14 may include time series (e.g., time series 316, 320, and 324 arranged in panel 306), alphanumeric readouts (e.g., text boxes 310, 312, and 314), identification information (e.g., text box 302 showing a patient ID), selectable options (e.g., option bar 326), any other suitable text, graphic, image, or information (e.g., text box 304), or any combination thereof. Illustrative display 300 includes time series of pulse rate (time series 316), SpO₂ (time series 320), and respiration rate (time series 324), although any suitable values, time series, related information (e.g., trend, slope, average, metrics derived thereof), or combinations thereof may be displayed.

In some embodiments, display 300 may include alarm limits or other indicators. For example, display 300 may include a high limit, low limit, or both, for a physiological parameter as shown illustratively by alarm limits 318 for pulse rate time series 316 in FIG. 3. If a suitable value of pulse rate (e.g., instantaneous value, moving average value, ensemble average value, previous value, value at a discrete time) falls outside of the high and low limits, an alarm condition may be satisfied and an alarm may be activated. In a further example, rate of change limit 322 may be displayed by display 300. Although alarm limits are shown in illustrative display 300 for clarity, alarm limits and conditions need not be displayed.

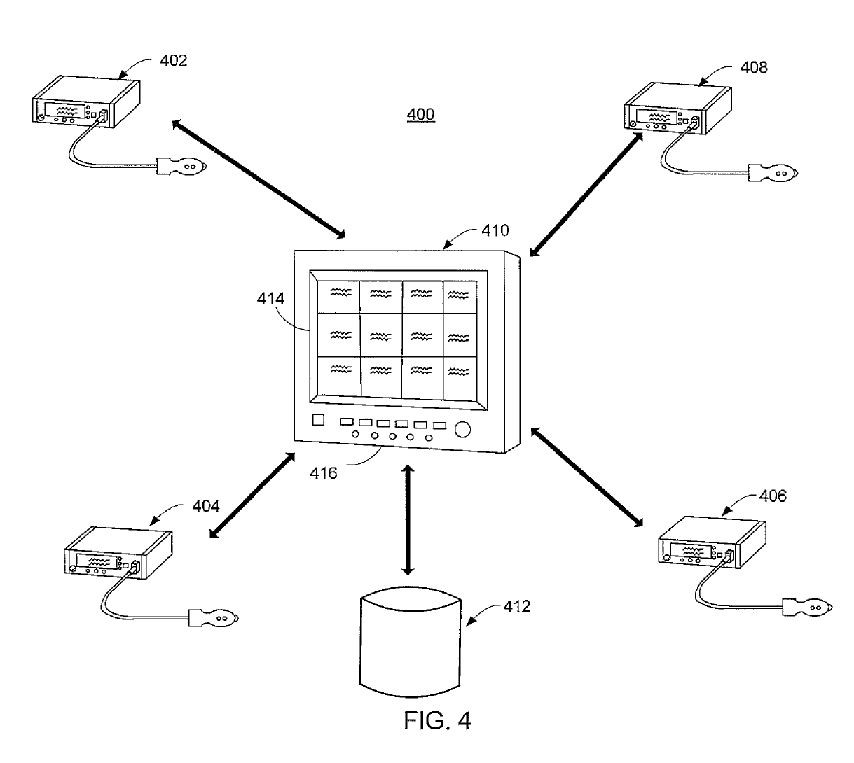

FIG. 4 shows an illustrative patient monitoring network, in some embodiments of the present disclosure. Patient monitoring network 400 may include patient monitoring systems 402, 404, 406, and 408, monitoring station 410, and database 412. Patient monitoring systems 402, 404, 406, and 408, may include any patient monitoring system such as patient monitoring system 10 described above, and different types of patient monitoring systems may be included in a single patient monitoring network 400. Although four patient monitoring systems have been depicted, more or fewer patient monitoring systems may operate in patient monitoring network 400. For example, a single monitoring station 410 may be able to communicate with a single patient monitoring system or numerous patient monitoring systems.

A monitoring station 410 may monitor and display information from one or more patient monitoring systems such as monitoring patient monitoring systems 402, 404, 406, and 408. Monitoring station 410 may be located remotely from one or more of patient monitoring systems 402, 404, 406, and 408. For example, monitoring station 410 may be located at a central location such as a nursing station while each of patient monitoring systems 402, 404, 406, and 408 may be at a patient location such as a patient room.

Monitoring station 410 may include a processor for processing data received from one or more patient monitoring systems, processing inputs to the monitoring station, displaying information on a display 414, communicating with other devices over a network, and other performing other tasks. Monitoring station 410 may also include memory for storing measured or calculated physiological parameters, patient information, and other data or information for the operation of monitoring station 410. Monitoring station 410 may include a display 414 configured to display the physiological parameters or other information received from one or more patient monitors of patient monitoring systems 402, 404, 406, and 408. For example, monitoring station 410 may be configured to display SpO₂ values, pulse rate information and blood pressure on display 414 based on values of received signals from the one or more of patient monitoring systems 402, 404, 406, and 408. Such values may be calculated elsewhere, e.g. at a sensor of a patient monitoring system, a patient monitor of a patient monitoring system, or by monitoring station 410 based on information received from one or more patient monitoring systems.

In the embodiment shown, monitoring station 410 may also include a speaker to provide an audible sound that may be used in various embodiments, such as for example, sounding an audible alarm in the event that a patient's physiological parameters are not within a predefined normal range. In some embodiments, user interface 416 may be provided to allow a user to navigate menus and information depicted on display 414. User interface 416 may include buttons, knobs, touchscreen, a keyboard, a mouse, or any other interface that allows a user to interact with monitoring station 410. User interface 416 may be used to enter information, select one or more options, provide a response, input settings, any other suitable inputting function, or any combination thereof. User interface 416 may be used to enter information about the patient, such as age, weight, height, diagnosis, medications, treatments, room assignment and so forth. In some embodiments, display 414 may exhibit a list of values which may generally apply to the patient, such as, for example, age ranges or medication families, which the user may select using user interface 416. In some embodiments, display 414 may exhibit one or more selectable options such as alarm settings, alarm sensitivity, or both which the user may select using user interface 416.

Monitoring station 410 may also include one or more mechanisms to facilitate communication with other devices in a network environment, such as patient monitoring systems 402, 404, 406, and 408, and database 412. For example, monitoring station 410 may include transceivers (internal or attached) such as a network port (such as an Ethernet port), a WiFi card, router, or any other device that allows signals to be exchanged between monitoring station 410 and other devices on a network, such as servers, routers, patient monitors, workstations and so forth. In some embodiments, such network functionality may be facilitated by the inclusion of a networking chipset within the monitoring station 410, by a processor of monitoring station 410, a module such as a network interface card, an external device that connects to a port of monitoring station 410, or combinations of the above.

Database 412 may be any data storage system capable of storing patient information. For example, database 412 may store patient information such as a patient ID, name, room number, insurance information, medications, treatments, real-time and historical monitoring information (e.g., physiological parameters, alarm status, sensor signals, etc.), and any other information or documents related to treatment of a patient. Monitoring station 410 may communicate with database 412 to retrieve patient information for display, analysis or modification. For example, monitoring station 410 may send identifying information such as a patient ID to database 412 to retrieve additional information related to a patient.

FIG. 5 is an illustrative monitoring station, in accordance with some embodiments of the present disclosure. Display portion 500 depicts an exemplary display of monitoring station 410. Monitoring station 410 may be capable of simultaneously displaying information received from one or more patient monitors. Monitoring station 410 may be configured in numerous manners, such as the twelve tiled blocks depicted in the example of FIG. 5. In this example, each tiled block may represent a patient monitoring system that is connected to the monitoring station. However, additional or fewer patient monitoring stations may be connected to monitoring station 410, and the display may change accordingly. In addition, the monitoring station may also display other information such as generalized patient information, menus, billing information, and any other relevant information.

Display portion 500 depicts an exemplary portion of the display of monitoring station 410 associated with a single patient monitor. Display portion 500 can include any information received from a patient monitor, the database, or information stored at the monitoring station. In this example, the patient monitor may provide physiological parameters relating to SpO₂ and heart rate to the monitoring station. The monitoring station 410 may display the SpO₂ level 506 and pulse rate 508 in display portion 500. However, any other physiological parameters capable of being monitored from a patient monitoring system as discussed herein may provide the source of the information to be displayed in display portion 500. Patient information such as a patient name 502 and room number 504 may be associated with a patient monitor and may also displayed in display portion 500. In addition, alarm limits associated with a patient, such as high and low SpO₂ level 506 (in this example, 94% and 88%) and pulse rate 508 (in this example, 100 and 48) may be displayed in display portion 500. Alarm limits may be established at the patient monitor, monitoring station, or stored in a database as described herein. Patient status information 510 may also be displayed in display portion 500.

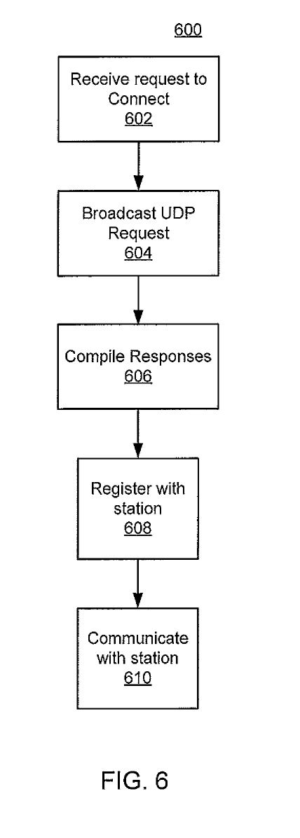

FIG. 6 is a flow diagram of illustrative steps 600 for establishing communications in a patient monitoring network, in accordance with some embodiments of the present disclosure. FIG. 6 is described with respect to a patient monitor establishing communications with a monitoring station, but similar steps could be used to establish communications from a monitoring station to a patient monitor. At step 602, a patient monitor may receive a request to establish communications with a monitoring station of a patient monitoring network. For example, the patient monitor may include a “connect” button, touch screen or other user interface for a user to request to register and communicate with a monitoring station. A processor of the patient monitor may process the request and initiate steps to connect to the patient monitoring network.

At step 604, the patient monitor may issue a broadcast request over a network. For example, the patient monitor may be connected to an Internet Protocol (IP) network such as through a WiFi or ethernet connection. Devices on the network such as patient monitors and monitoring stations may have IP addresses, which may be established such as with the Dynamic Host Configuration Protocol (DHCP). Although monitoring stations may have established IP addresses, the patient monitor may not be aware of the IP addresses on the network. A broadcast request requesting IP addresses for all monitoring stations on the network may allow for the automatic configuration of the patient monitor within a patient monitoring network without knowing the IP addresses of the monitoring stations.

The broadcast request may utilize the User Datagram Protocol (UDP) or other suitable broadcast protocol to send a broadcast message to devices on the network. The broadcast message may include information identifying the requesting patient monitor to other devices on the network, such as an IP address, patient monitor ID, station name or identifier, and/or other information to identify the patient monitor. The broadcast request may also include a request that any monitoring stations (or other devices) attached to the network provide identifying information, such as an IP address, station ID, station name or identifier, and/or other information to identify the monitoring station to the patient monitor.

Monitoring stations (or other devices) attached to the network may respond by establishing addressed communications according to a protocol and based on the information from the broadcast request. For example, the monitoring station and patient monitor may utilize the transmission control protocol (TCP) to establish the parameters and protocol for addressed communications, and the monitoring station may send an addressed message to the requesting patient monitor at the IP address indicated in the broadcast message. The monitoring station may respond with identifying information, such as an IP address, station ID, station name or identifier, and/or other information to identify the monitoring station to the patient monitor.

At step 606, the patient monitor may compile all responses from monitoring stations. The patient monitor may optionally automatically select a monitoring station of the one or more responding monitoring stations, such as through programmed or preexisting default settings. Alternatively, the patient monitor may provide an indication of the responding stations to the user, such as by displaying station names or station IDs to the user. The user may utilize the user interface of the patient monitor to select one or more monitoring stations to communicate with. For example, the user may navigate a cursor to a desired monitoring station and press a select or okay key. As another example, the monitoring stations may be displayed in a numbered list and the user may select a number key corresponding to the desired monitoring station.

At step 608, the patient monitor may register with the monitoring station. The patient monitor may transmit an addressed message (e.g., utilizing TCP) to the selected monitoring station including information such as patient information, patient ID, and information relating to the type of patient monitor (e.g., pulse oximeter). The monitoring station may utilize this information to configure a display for a display area of the monitoring station. Identifying information such as a patient ID (e.g., from the broadcast request or register request) may be used to retrieve information from the database such as a patient name and room number for display at the monitoring station.

At step 610 the registered patient monitor and the monitoring station may communicate using addressed messages (e.g., utilizing TOP). As described herein, a monitoring station may display information relating to multiple patient monitors at any one time. The monitoring station may send addressed messages seeking updated patient information from the patient monitor. For example, the monitoring station may request updated measurements of physiological parameters such as SpO₂ or pulse rate. The patient monitor may also regularly (e.g., according to a schedule) send information to the monitoring station. Other information may be sent regularly or asynchronously from a patient monitor such as any patient alarm messages. For example, if SpO₂ or pulse rate exceeds an alarm limit, the patient monitor may automatically transmit a message to the monitoring station, without waiting for a request for information or for the next scheduled transit time. Additionally, the monitoring station and patient monitor may send other information using addressed messages, such as modifications to operating parameters or settings. The patient monitor and monitoring station may communicate until either terminates the association, such as in response to a user request.

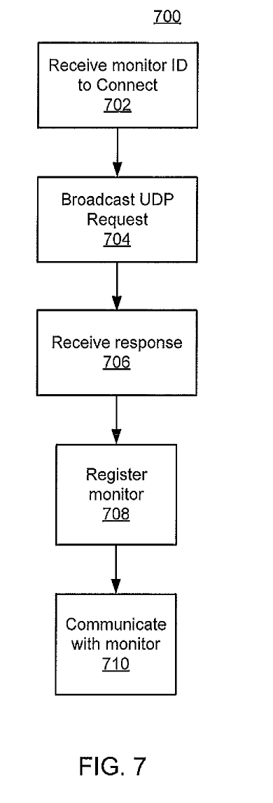

FIG. 7 is a flow diagram of illustrative steps 700 for establishing communications from a monitoring station in a patient monitoring network, in accordance with some embodiments of the present disclosure. FIG. 7 is described with respect to a monitoring station establishing communications with a patient monitor, but similar steps could be used to establish communications from a patient monitor to a monitoring station. At step 702, a monitoring station may receive a request to connect to a patient monitor. An exemplary request may include entry of a patient monitor ID or other identifying information of a patient monitor from a user interface of the monitoring station. A processor of the monitoring station may process the request and initiate steps to communicate with a patient monitor of the patient monitoring network.

At step 704, the monitoring station may issue a broadcast request over a network. For example, the monitoring station may be connected to an IP network such as through a WiFi or ethernet connection. Devices on the network such as patient monitors and monitoring stations may have IP addresses, which may be established such as with DHCP. Although patient monitors may have established IP addresses, the monitoring station may not be aware of the IP addresses on the network. A broadcast request including identifying information for the patient monitor (e.g., patient monitor ID) may allow for the automatic configuration of the patient monitor within a patient monitoring network without knowing the IP address of the patient monitor.

The broadcast request may utilize UDP or another suitable broadcast protocol to send a broadcast message to devices on the network. In addition to the identifying information for the patient monitor, the broadcast request may also include information identifying the monitoring station to other devices on the network, such as an IP address, monitoring station ID, monitoring station name or identifier, and other information to identify the monitoring station. The broadcast request may also include a request that the patient monitor indicated by the user (e.g., by patient monitor ID) respond with additional identifying information, such as an IP address, station ID, station name or identifier, and/or other information to identify the patient monitor to the monitoring station. Alternatively, a monitoring station could indicate that all patient monitors should respond or that particular types of patient monitors (e.g., pulse oximeters) should respond.

Any patient monitors attached to the network may receive the request and determine whether to respond. If a particular patient monitor is identified in the broadcast request (e.g., by patient monitor ID), the patient monitor indicated in the request may respond by establishing addressed communications according to a protocol based on the information from the broadcast request. For example, the patient monitor and monitoring station may utilize TCP messaging to establish the parameters and protocol for addressed communications, and the patient monitor may send an addressed message to the requesting monitoring station. The patient monitor may respond with identifying information, such as an IP address, station ID, station name or identifier, and/or other information to identify the patient monitor to the monitoring station.

At step 706, the monitoring station may receive the response message and determine whether to register the patient monitor. For example, monitoring station may confirm the patient monitor based on the patient monitor ID, or may confirm the patient monitor with additional identifying information received from the patient monitor.

At step 708, the monitoring station may register the patient monitor. The monitoring station may utilize the received information to configure a display for a display area of the monitoring station appropriate for the physiological parameters being monitoring by the patient monitor. Identifying information such as a patient ID can be used to retrieve information from the database such as a patient name and room number for display at the monitoring station.

At step 710 the registered patient monitor and the monitoring station may communicate using addressed messages (e.g., utilizing TCP). As described herein, a monitoring station may display information relating to multiple patient monitors at any one time. The monitoring station may send messages seeking updated patient information from the patient monitors. For example, the monitoring station may request updated measurements of parameters such as SpO₂or pulse rate. Alternatively, the patient monitor may regularly (e.g., according to a schedule) send such information to the monitoring station. Other information may be sent regularly or asynchronously from a patient monitor such as any patient alarm messages. For example, if SpO₂ or pulse rate exceeds an alarm limit, the patient monitor may automatically transmit a message to the monitoring station. Additionally, the monitoring station and patient monitor may send other information using addressed messages, such as modifications to operating parameters or settings. The patient monitor and monitoring station may communicate until either terminates the association, such as in response to a user request.

The steps of flow diagrams 600 and 700 are merely illustrative and be combined with other steps, omitted, rearranged, or otherwise altered in accordance with the present disclosure. For example, in flow diagram 600 it was described that at step 608 patient information, patient ID, and/or information relating to the type of patient monitor may be transmitted to the monitoring station. It will be understood that this information may instead be transmitted to the monitoring station at step 604. As another example, in flow diagram 700 it was described that at step 702 the request to connect to a patient monitor may include the patient monitor ID. It will be understood that this information may not be included and instead the monitoring station may request a response from all available patient monitors or all patient monitors not currently connected to a patient monitoring network. Once the responses are received, the monitoring station may display the available patient monitors and a user may select to connect to a desired patient monitor.

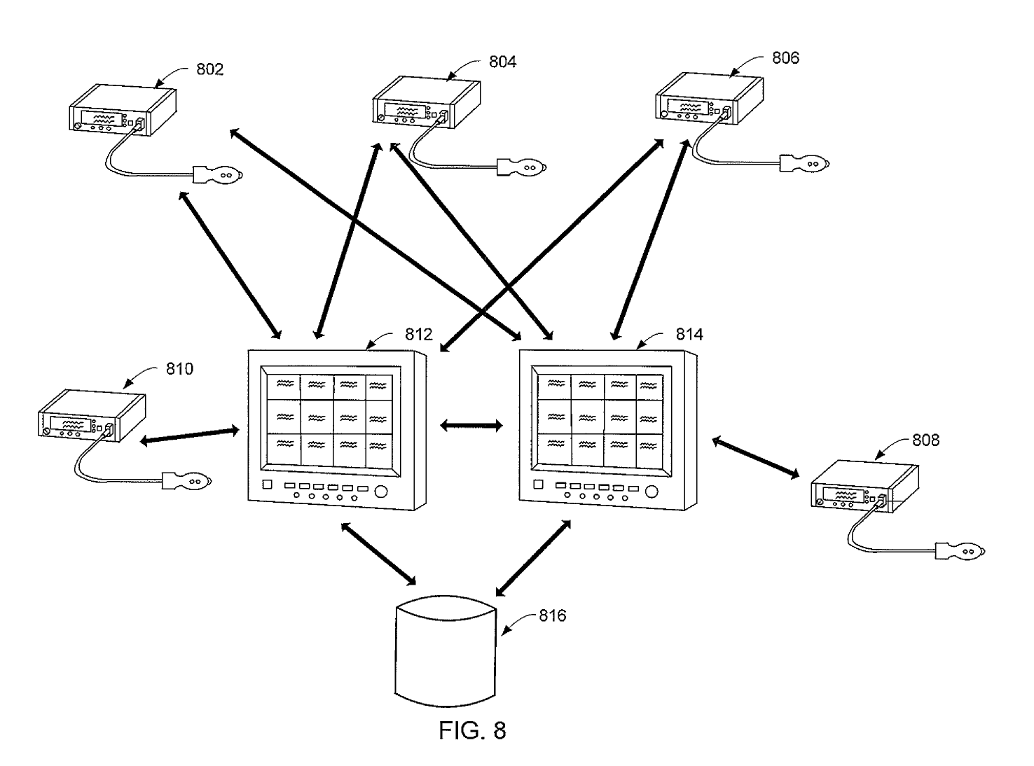

FIG. 8 shows an illustrative patient monitoring network, in accordance with some embodiments of the present disclosure. As described herein, a monitoring station may communicate with multiple patient monitors. In addition, a patient monitor may communicate with multiple monitoring stations that are on the same network, for example by repeating the steps of FIG. 6 to select additional monitoring stations, registering with multiple monitoring stations initially, or by receiving additional requests to register from one or more monitoring stations as described in FIG. 7. In the example of FIG. 8, a patient monitoring network may be established at monitoring stations 812 and 814. Monitoring station 812 may establish communications with a plurality of patient monitors, such as patient monitors 802, 804, 806, and 810. Monitoring station 814 may establish communications with a plurality of patient monitors, such as patient monitor 802, 804, 806, and 808. Accordingly, patient monitors 802, 804, and 806 may communicate information for display and monitoring at both of monitoring stations 812 and 814. Monitoring stations 812 and 814 may also communicate with database 816 as described herein. Monitoring stations 812 and 814 may also be in direct communication for communicating information such as alarms and patient information.

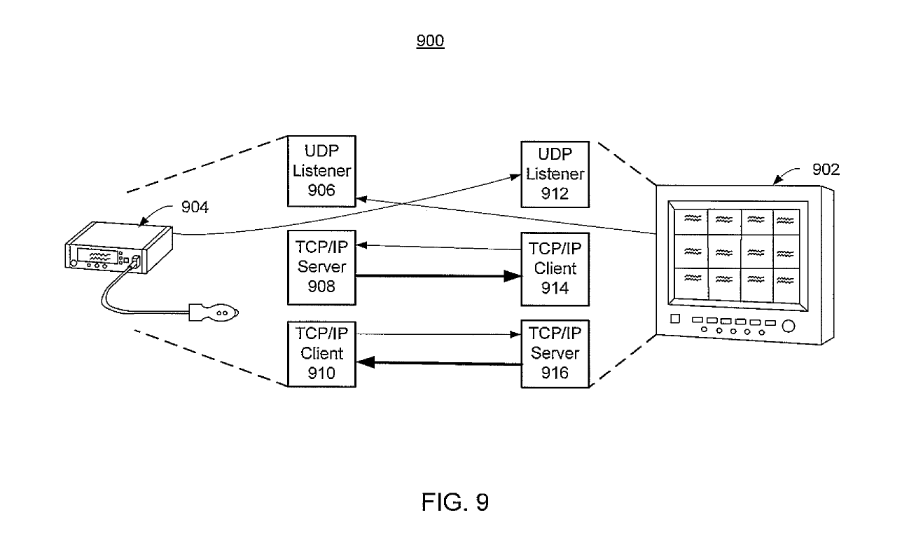

FIG. 9 shows an illustrative communication architecture 900 for a patient monitoring network, in accordance with some embodiments of the present disclosure. Although communication architecture 900 is depicted with monitoring station 902 and patient monitor 904, it will be understood that this embodiment could be implemented between monitoring stations and/or between patient monitors, and could also include other devices. Monitoring station 902 may include UDP listener 912, TCP/IP client 914, and TCP/IP server 916. Patient monitor 904 may include UDP listener 906, TCP/IP server 908, and TCP/IP client 910.

Monitoring station 902 and patient monitor 904 may be configured to send UDP broadcast requests. UDP listener 906 of patient monitor 904 and UDP listener 912 of monitoring station 902 may be capable of receiving UDP protocol information over a network, such as the UDP broadcast messages described herein. For example, UDP listener 906 may receive UDP messages such as from monitoring station 902, which may include an IP address of monitoring station 902 and identifying information for patient monitor 904 as part of a request to establish communications in a patient monitoring network. In another example, UDP listener 912 may receive UDP messages such as from patient monitor 904, which may include an IP address of patient monitor 904 and a request for monitoring stations to respond to patient monitor 904 to establish communications in a patient monitoring network.

Communications in a patient monitoring network may be implemented by addressed communications between TCP/IP server 908 and TCP/IP client 914, and TCP/IP server 916 and TCP/IP client 910, respectively. TCP/IP server 908 may provide server functionality with respect to communications where monitoring station 902 requests information or services from patient monitor 904. For example, when monitoring station 902 requests information relating to physiological parameters from patient monitor 904, TCP/IP client 914 may request information from TCP/IP server 908. TCP/IP server 908 may perform processes including retrieving information relating to measured physiological parameters from patient monitor 904 and may transmit responsive information to TCP/IP client 914. It will be understood that the retrieval of physiological parameters is exemplary only, and that any information or services performed by patient monitor 904 may be requested via TCP/IP server 908.

TCP/IP server 916 may provide server functionality with respect to communications where patient monitor 904 requests information or services from monitoring station 902. For example, when patient monitor 904 requests information relating to patient identifying information from monitoring station 902, TCP/IP client 910 may request information from TCP/IP server 916. TCP/IP server 916 may perform processes including retrieving information relating to identifying information from monitoring station 902 and may transmit responsive information to TCP/IP client 910. It will be understood that the retrieval of patient identifying information is exemplary only, and that any information or services performed by monitoring station 902 may be requested via TCP/IP server 916.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof which are within the spirit of the following claims.

What is claimed is:

1. A method for a first patient monitoring unit to communicate within a patient monitoring network, comprising:
transmitting a broadcast message over a network;
receiving a response message to the broadcast message from a second patient monitoring unit; and
communicating with the second patient monitoring unit based on the response message.

2. The method of claim 1, wherein the broadcast message comprises a UDP broadcast message.

3. The method of claim 1, wherein the response message comprises an IP address of the second patient monitoring unit.

4. The method of claim 3, wherein communicating with the second patient monitoring unit based on the response message comprises:
receiving a user indication selecting the second patient monitoring unit;
associating the second patient monitoring unit with the IP address; and
transmitting TCP messages to the second patient monitoring unit.

5. The method of claim 1, further comprising:
receiving signals corresponding to one or more physiological parameters for a patient;
comparing the signals to at least one alarm threshold; and
transmitting an alarm message to the second patient monitoring unit based on the comparing.

6. The method of claim 1, further comprising:
receiving signals corresponding to physiological parameters for a patient;
storing patient data in memory based on the signals;
receiving a request for at least a portion of the patient data from the second patient monitoring unit; and
transmitting the at least a portion of the patient data to the second patient monitoring unit.

7. The method of claim 1, further comprising:
receiving patient identifying information from the second patient monitoring unit; and
retrieving additional patient information based on the patient identifying information.

8. The method of claim 1, further comprising:
receiving a second response message to the broadcast message from a third patient monitoring unit; and
communicating with the third patient monitoring unit based on the second response message.

9. The method of claim 1, further comprising:
receiving a broadcast message from a third patient monitoring unit over the network;
transmitting a response message to the third patient monitoring unit; and
receiving physiological parameter information from the third patient monitoring unit.

10. The method of claim 9, further comprising:
receiving physiological parameter information from the second patient monitoring unit; and
concurrently displaying physiological parameter information received from the second patient monitoring unit and the third patient monitoring unit.

11. A patient monitoring unit comprising:
a transceiver; and
a processor coupled to the transceiver, the processor configured to enable the transceiver to transmit a broadcast message over a network, receive a response message to the broadcast message from at least a second patient monitoring unit, and communicate with the second patient monitoring unit based on the response message.

12. The patient monitoring unit of claim 11, wherein the broadcast message comprises a UDP broadcast message.

13. The patient monitoring unit of claim 11, wherein the response message comprises an IP address of the second patient monitoring unit.

14. The patient monitoring unit of claim 13, further comprising a user interface coupled to the processor, the user interface to enable a user to select the second patient monitoring unit, the processor further configured to associate the second patient monitoring unit with the IP address and enable the transceiver to transmit TCP messages to the second monitoring unit.

15. The patient monitoring unit of claim 11, the processor further configured to receive signals corresponding to one or more physiological parameters for a patient, compare the signals to at least one alarm threshold, and enable the transceiver to transmit an alarm message to the second patient monitoring unit based on the comparison of the signals to the at least one alarm threshold.

16. The patient monitoring unit of claim 11, the processor further configured to receive signals corresponding to physiological parameters for a patient, store patient data in memory based on the signals, and enable the transceiver to receive a request for at least a portion of the patient data from the second patient monitoring unit and transmit the at least a portion of the patient data to the second patient monitoring unit.

17. The patient monitoring unit of claim 11, the processor further configured to enable the transceiver to receive patient identifying information from the second patient monitoring unit, the processor further configured to retrieve additional patient information based on the patient identifying information.

18. The patient monitoring unit of claim 11, the processor further configured to enable the transceiver to receive a second response message to the broadcast message from a third patient monitoring unit and communicate with the third patient monitoring unit based on the second response message.

19. The patient monitoring unit of claim 11, the processor further configured to enable the transceiver to receive a broadcast message from a third patient monitoring unit over the network, transmit a response message to the third patient monitoring unit, and receive physiological parameter information from the third patient monitoring unit.

20. The patient monitoring unit of claim 19, further comprising a display coupled to the processor, the processor configured to enable the transceiver to receive physiological parameter information from the second patient monitoring unit, and configured to enable the display to concurrently display received information from the second patient monitoring unit and the third patient monitoring unit.
